(19) United States
(12) Patent Application Publication
(10) Pub. No.: US 2026/0025024 A1
(43) Pub. Date: Jan. 22, 2026

(54) COIL COMPONENT AND WIRELESS POWER TRANSMISSION DEVICE HAVING THE SAME

(71) Applicant: TDK Corporation, Tokyo (JP)

(72) Inventors: Michihisa TOKUI, Tokyo (JP); Sumin Kumar Chalise, Tokyo (JP)

(73) Assignee: TDK Corporation, Tokyo (JP)

(21) Appl. No.: 19/344,986

(22) Filed: Sep. 30, 2025

(30) Foreign Application Priority Data
Sep. 30, 2024 (JP) 2024-170946

(51) Int. Cl. H02J 50/10; H01F 27/24; H01F 27/28; H02J 50/00; H02J 50/40; H02J 50/90

(52) U.S. Cl. CPC H02J 50/10; H01F 27/24; H01F 27/28; H02J 50/005; H02J 50/402; H02J 50/90

(57) ABSTRACT

Disclosed herein is a coil component that includes a first coil, a second coil disposed above the first coil, and a magnetic body disposed between the first coil and the second coil. The first coil is configured to be connectable to a part of turns of the second coil.

### CROSS-REFERENCE TO RELATED APPLICATION

This application claims the benefit of Japanese Patent Application No. 2024-170946, filed on Sep. 30, 2024, the entire disclosure of which is incorporated by reference herein.

### BACKGROUND

The present disclosure relates to a coil component and a wireless power transmission device having the coil component.

There are known wireless power transmission devices used as charging systems for mobile devices such as smartphones. For example, JP 2023-110784A discloses a wireless power feeding system configured to transmit and receive electric power using magnetism. This wireless power feeding system includes: a power transmission device having a power feeding coil and a power transmission coil; a power reception device having a power reception coil; a measurement part that measures a load current or a load voltage; and an impedance matching mechanism that performs impedance matching based on a measurement result from the measurement part. The power feeding coil is divided into a plurality of power feeding coil parts having different relative positions with respect to the power transmission coil, and the input-side impedance to the power transmission coil is adjusted by feeding power to at least one of the plurality of power feeding coil parts.

In recent years, wireless power transmission devices complying with both EPP (Extended Power Profile) standards and MPP (Magnetic Power Profile) standards have attracted attention. In such wireless power transmission devices, an EPP-compliant first coil and an MPP-compliant second coil are each required to transmit power with high efficiency.

### SUMMARY

A coil component according to an embodiment of the present disclosure includes: a first coil; a second coil disposed above the first coil; and a magnetic body disposed between the first coil and the second coil, wherein the first coil is configured to be connectable to a part of the turns of the second coil.

### BRIEF DESCRIPTION OF THE DRAWINGS

The above features and advantages of the present disclosure will be more apparent from the following description of certain embodiments taken in conjunction with the accompanying drawings, in which:

FIG. 1 is a schematic cross-sectional view illustrating the structure of a coil component according to an embodiment of the present disclosure;

FIG. 2 is a schematic plan view of the coil component as seen from the coil axis direction;

FIG. 3 is a schematic view illustrating the electrical connection between the first and second coils;

FIGS. 4 and 5 are views for explaining the operation of the coil component;

FIG. 6 is a schematic view illustrating another example of the electrical connection between the first and second coils;

FIG. 7 is a block diagram illustrating an example of the configuration of a wireless power transmission device using the coil component; and

FIG. 8 is a block diagram illustrating another example of the configuration of the wireless power transmission device 80 using the coil component.

### DETAILED DESCRIPTION OF THE EMBODIMENTS

An object of the present disclosure is therefore to provide a coil component capable of suppressing a reduction in power transmission efficiency in either case where the first coil or the second coil is used.

Some embodiments of the present disclosure will be explained below in detail with reference to the accompanying drawings.

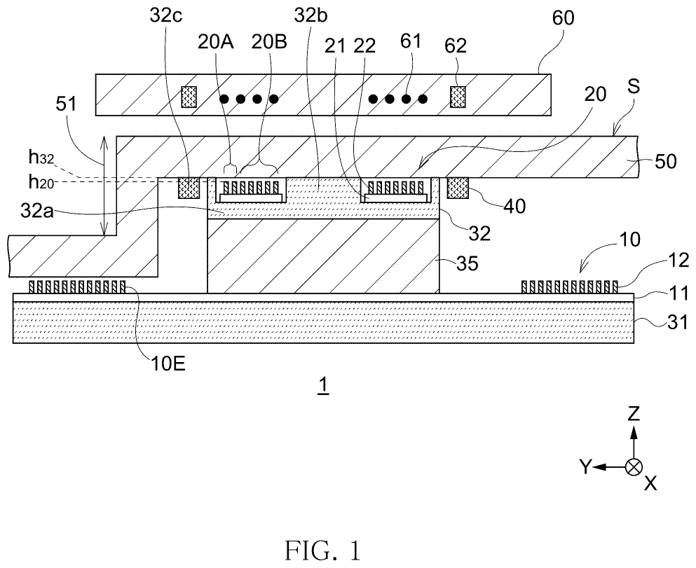

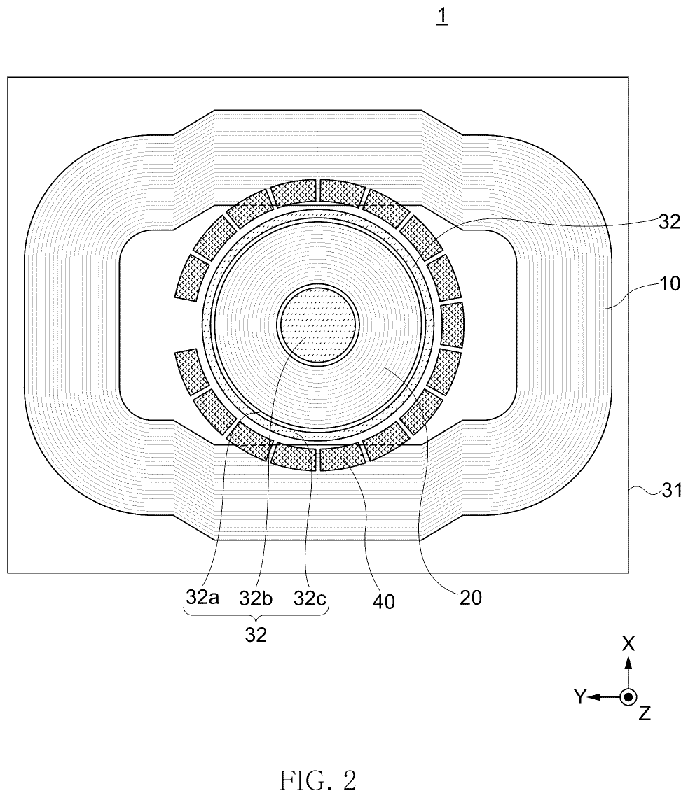

FIG. 1 is a schematic cross-sectional view illustrating the structure of a coil component 1 according to an embodiment of the present disclosure. FIG. 2 is a schematic plan view of the coil component 1 as seen from the coil axis direction.

As illustrated in FIGS. 1 and 2, the coil component 1 according to one embodiment of the present disclosure includes a first coil 10, a second coil 20 disposed above the first coil 10, a first magnetic body 31 disposed below the first coil 10, a second magnetic body 32 disposed between the first coil 10 and the second coil 20, and a magnet 40 disposed radially outside the second coil 20.

The vertical direction of the coil component 1 is defined by the Z-direction, which corresponds to the coil axis direction of the first and second coils 10 and 20. An electronic device 60 (device to be charged), such as a smartphone, is disposed above the coil component 1, and power is wirelessly transmitted from the coil component 1 to the electronic device 60. That is, the Z-direction in FIG. 1 corresponds to the direction of power transmission direction. It should be noted that the expression “vertical direction” is used to refer to the arrangement direction and is not associated with the gravitational 15 direction. Therefore, the vertical direction may include, for example, a case where power is transmitted toward the lower side, which is the gravitational direction.

The first magnetic body 31, the first coil 10, the second magnetic body 32, and the second coil 20 are stacked in this order in the coil axis direction (power transmission direction).

The first and second coils 10 and 20 both function as power transmission coils for wireless power transmission. More specifically, the first coil 10 is primarily used to achieve a wide charging area, while the second coil 20 is primarily used to enhance power transmission efficiency around the center of the charging area.

The first coil 10 is primarily used for wireless power transmission in EPP mode, while the second coil 20 is primarily used for wireless power transmission in MPP mode. The EPP is one of the wireless charging standards, capable of fast charging with a maximum output of 15 W and enables safe wireless power transmission through bidirectional communication between the power transmission side and the power reception side. The MPP, also known as the Qi2 standard, is a type of wireless charging standard that achieves high power transmission efficiency and convenience by using magnets to accurately align the power transmission coil and the power reception coil.

The first coil 10 is constituted by a planar coil pattern 12 formed on the surface of a substrate 11 made of a resin film. Examples of the resin film include PET (polyethylene terephthalate) and PI (polyimide). The coil pattern is a conductor pattern, and the conductor may be copper, aluminum, or an alloy thereof. This makes it possible to provide a very thin planar coil.

The first coil 10 has a planar shape elongated in the Y-direction, in which the width in the Y-direction is larger than that in the X-direction. The first coil 10 may be larger in overall dimensions than the second coil 20. This enables coverage of a wide charging area. The overall dimensions of the coil are defined by the maximum outer dimensions of the area surrounded by the outermost turn of the coil.

Although details will be described later, the first coil 10 is configured to be connected to one or more turns of the second coil 20. Connecting one or more turns of the second coil 20 to the first coil 10 enables driving those turns together with the first coil 10 during power transmission, thereby enhancing power transmission efficiency.

The second coil 20 is constituted by a planar coil pattern 22 formed on the surface of a substrate 21 made of a resin film. Examples of the resin film include PET and PI. The coil pattern is a conductor pattern, and the conductor may be copper, aluminum, or an alloy thereof. The second coil 20 may be a winding coil formed by winding copper wire. When configured as such, a high-inductance, large-current coil can be provided at low cost. Furthermore, in this case, it is easy to form an intermediate tap or the like.

The second coil 20 has a substantially circular planar shape, with the width in the Y-direction approximately equal to that in the X-direction. The second coil 20 may be smaller in overall dimensions than the first coil 10. This enables the magnetic coupling around the center of the charging area to be enhanced.

Although details will be described later, the second coil 20 is formed by combining a first winding part 20A (an outer peripheral coil pattern) and a second winding part 20B (an inner peripheral coil pattern), with lead-out parts provided at three locations: the outer peripheral end of the second coil 20, the inner peripheral end of the second coil 20, and the connection part between the first winding part 20A and the second winding part 20B. Assuming the total number of turns of the second coil 20 is six, for example, the first winding part 20A may be composed of two turns on the outer peripheral side, and the second winding part 20B is composed of four turns on the inner peripheral side. Although the ratio of the number of turns between the first and second winding parts 20A and 20B is not particularly limited, the number of turns of the first winding part 20A may be one or more turns and less than the number of turns of the second winding part 20B. When the first winding part 20A includes the outermost turn of the second coil 20, the inner diameter (opening) of the second coil 20 increases. As a result, even if displacement occurs between the power transmission coil and the power reception coil, a reduction in magnetic coupling between them can be suppressed.

The first magnetic body 31 and the second magnetic body 32 function as magnetic paths for the magnetic flux generated by the first coil 10 and the second coil 20, respectively. Each of the first and second magnetic bodies 31 and 32 may be formed of a magnetic material having a relative permeability of 300 or greater. This enables achievement of high inductance.

The first magnetic body 31 is formed of a thin magnetic sheet and is disposed below the first coil 10. The first magnetic body 31 is larger in overall dimensions than the first coil 10. Accordingly, the first magnetic body 31 entirely covers the back surface of the first coil 10.

The second magnetic body 32 is a thin magnetic core that is circular in a plan view and substantially E-shaped in cross section and is disposed between the first coil 10 and the second coil 20. The second magnetic body 32 is larger in overall dimensions than the second coil 20 and smaller than the first coil 10. Accordingly, the second magnetic body 32 entirely covers the back surface of the second coil 20.

The second magnetic body 32 has a bottom plate part 32a that is circular in a plan view, a columnar center protruding part 32b provided at the center of the upper surface of the bottom plate part 32a, and a substantially annular outer protruding part 32c provided at the peripheral edge of the upper surface of the bottom plate part 32a. The center protruding part 32b and the outer protruding part 32c protrude upward from the upper surface of the bottom plate part 32a. The second coil 20 is accommodated in a concave portion formed between the center protruding part 32b of the second magnetic body 32 and the outer protruding part 32c thereof.

The outer protruding part 32c is an annular side wall portion that covers the outer peripheral end face of the second coil 20. The height h₃₂ at the upper end of the outer protruding part 32c may be larger than the height h₂₀ of the upper surface of the second coil 20. When the height of the upper surface of the second coil 20 is not uniform, the maximum height thereof is defined as the height of the upper surface of the second coil 20. The magnet 40 is disposed in a substantially annular shape outside the second magnetic body 32, and the second coil is susceptible to the influence of the magnet 40. However, when the height h₃₂ at the upper end of the outer protruding part 32c is larger than the height h₂₀ of the upper surface of the second coil 20, the influence of the magnet 40 can be reduced, thereby suppressing a reduction in the power transmission efficiency of the second coil 20.

In the longitudinal direction (Y-direction) of the first coil 10, the outer protruding part 32c of the second magnetic body 32 may be positioned so as to overlap an inner peripheral edge 10E of the winding area of the first coil 10, or may be positioned on the inner side thereof, as illustrated. This configuration enables a reduction in the influence of the second magnetic body 32 on the first coil 10 and suppresses a reduction in the magnetic coupling of the first coil 10.

When in use, the electronic device 60 including the power reception coil 61 is placed on a placement surface S illustrated in FIG. 1, and power is wirelessly transmitted from the coil component 1 to the electronic device 60 by the magnetic coupling between one of the first and second coils 10 and 20 (the power transmission coil) and the power reception coil 61.

The magnet 40 is disposed in an annular shape along the outer shape of the second coil 20 so as not to overlap the second coil 20. As used herein, the phrase “disposed in an annular shape” refers not only to a state in which the magnet 40 is disposed in a complete ring shape, but also to a state in which a portion of the magnet 40 is absent, as illustrated in FIG. 2. The magnet 40 is fixed in position at least in the XY-plane direction of the second coil, and the power reception coil 61 is positioned relative to the second coil 20 by an attractive force that acts between the magnet 40 and a magnet 62 provided on the electronic device 60 side. The magnet 40 may be supported by a support member made of resin or the like.

A non-metallic spacer block 35 is provided between the first coil 10 and the second magnetic body 32, and thus, the first coil 10 is spaced apart from the second coil 20 in the Z-direction by a predetermined distance. The difference in height between the upper surface of the first coil 10 and the upper surface of the second coil 20 may be 5 mm or greater. This enables a large step 51 corresponding to the difference in height between the upper surface of the first coil 10 and the upper surface of the second coil 20 to be formed on the upper surface of a housing 50 that houses the coil component 1. The height of the step 51 may be 5 mm or greater, and may particularly be in the range of 6 to 7 mm. The distance between the first and second coils 10 and 20 is sufficiently larger than the thicknesses of the first and second coils 10 and 20.

A camera lens is provided on the back side of a smartphone, which is a typical device to be charged. In particular, in recent smartphones, the camera lens often protrudes significantly from the back surface. When such a protrusion is present on the back side of the smartphone, the protrusion may interfere with the housing of a wireless power transmission system (wireless charger) that houses the coil component 1. Therefore, depending on the position of the power reception coil 61 inside the smartphone, it may not be possible to align the power reception coil 61 with the center of the power transmission coil. Further, even when a positioning magnet 62 is provided on the smartphone side, the camera lens may interfere with the housing, preventing the magnet 62 from being attracted to the magnet 40 on the coil component 1 side. This may result in a failure of the MPP mode to function effectively.

However, in the present embodiment, the second coil is disposed sufficiently separated from the first coil in the coil axis direction. This enables the step 51 to be formed on the upper surface (placement surface S) of the housing 50 that houses the coil component 1, thereby avoiding interference with the protrusion of a device to be charged.

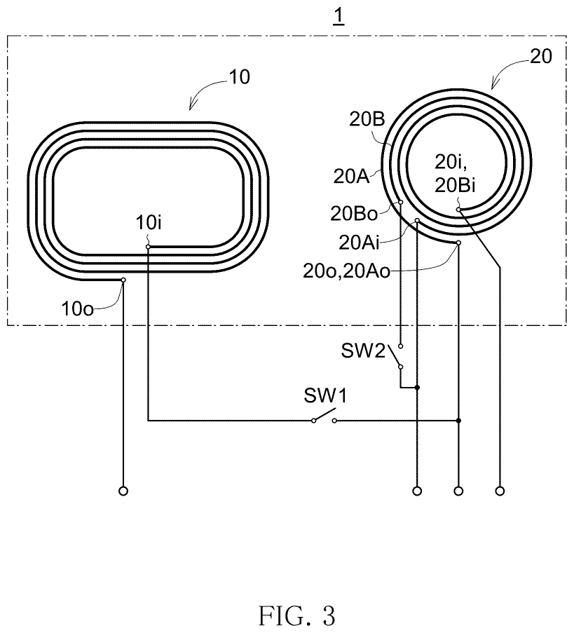

FIG. 3 is a schematic view illustrating the electrical connection between the first and second coils 10 and 20.

As illustrated in FIG. 3, the first coil 10 is a planar spiral coil. An inner peripheral end 10i of the first coil 10 is drawn outside the winding area by a lead-out wire and connected to the outer peripheral end 20o of the second coil 20 through a switch SW1 (first switch). For descriptive convenience, the number of turns of the first coil 10 is set to substantially four.

The second coil 20 has the first winding part 20A (outer winding part) constituting the outer winding and the second winding part 20B constituting the inner winding. Lead-out wires are connected to the outer and inner peripheral ends of each of the first and second winding parts 20A and 20B. For descriptive convenience, the number of turns of the second coil 20 is set to four, with the first winding part 20A having the outermost substantially one turn and the second winding part 20B having the remaining substantially three turns.

The outer peripheral end 20Ao of the first winding part 20A corresponds to the outer peripheral end 20o of the second coil 20, and the inner peripheral end 20Bi of the second corresponds to an inner peripheral end 201 of the second coil 20. An inner peripheral end 20Ai of the first winding part 20A and an outer peripheral end 20Bo of the second winding part 20B are drawn outside the winding area of the second coil 20 by lead-out wires. Further, the inner peripheral end 20Ai of the first winding part 20A is configured to be connectable to the outer peripheral end 20Bo of the second winding part 20B through a switch SW2 (second switch).

Thus, when the switch SW2 is turned ON, the first and second winding parts 20A and 20B are electrically connected in series to form a single coil.

The first winding part 20A is a planar spiral coil, and the second winding part 20B is also a planar spiral coil located on the same plane as the first winding part 20A. The second winding part 20B is disposed on the inner peripheral side of the first winding part 20A, and the outer peripheral end 20Bo of the second winding part 20B is adjacent to the inner peripheral end Ai of the first winding part 20A. That is, the winding of the second winding part 20B starts from a position in the vicinity of the inner peripheral end 20Ai of the first winding part 20A and extends along the innermost turn of the first winding part 20A. Thus, the apparent configuration of the second coil 20 is substantially the same as that of a single planar spiral coil formed by continuously winding a single conductive wire.

The number of turns of the first winding part 20A of the second coil 2 may be smaller than that of the first coil 10. For example, when the number of turns of the first coil 10 is eight, the number of turns of the first winding part 20A of the second coil 20 may be less than eight. When the number of turns of the first winding part 20A is smaller than that of the first coil 10, the first coil 10 exhibits a dominant action to thereby function properly as the EPP coil and to provide a wide charging area.

The above relationship can be represented by an inductance value. That is, the inductance of the first winding part 20A of the second coil 20 may be smaller than that of the first coil 10. This allows the first coil 10 to properly function as the EPP coil and to provide a wide charging area. Further, a combination of the first coil and the first winding part 20A can suppress a reduction in the magnetic coupling near the center of the first coil 10, thereby enhancing power transmission efficiency.

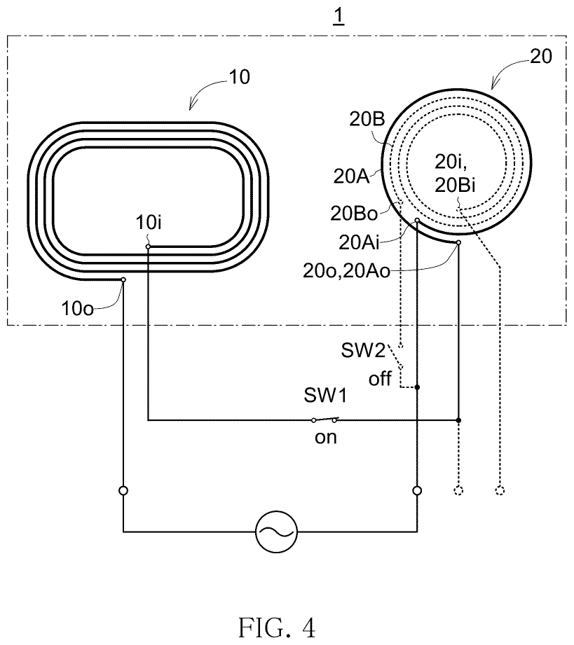

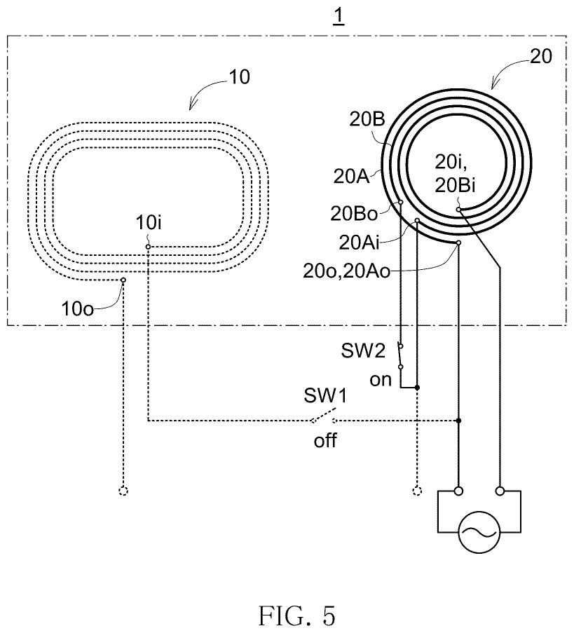

FIGS. 4 and 5 are views for explaining the operation of the coil component 1, in which FIG. 4 illustrates the EPP mode and FIG. 5 illustrates the MPP mode.

As illustrated in FIG. 4, when the coil component 1 operates in the EPP mode (first power transmission mode), the switch SW1 is turned ON and the switch SW2 is turned OFF. As a result, the first winding part 20A of the second coil 20 is connected in series with the first coil 10, while being disconnected from the second winding part 20B. That is, the combination of the first coil 10 and the first winding part 20A forms a single coil, and the first winding part 20A functions as part of the EPP coil. The pair of terminals of the EPP coil are denoted by the outer peripheral end 10o of the first coil 10 and the inner peripheral end 20Ai of the first winding part 20A, and a power transmission circuit is connected between the terminals to supply transmission power.

When current flows from the outer peripheral end 10o of the first coil 10 toward the inner peripheral end 10i thereof, the current flows clockwise. Likewise, when current flows from the outer peripheral end 20Ao of the first winding part 20A toward the inner peripheral end 20Ai thereof, the current also flows clockwise. This enables the loop current in the first coil 10 and the loop current in the first winding part 20A to flow in the same direction, allowing the first winding part 20A to function as part of the first coil 10. As described above, in the EPP mode, the first coil 10 is primarily used, with the part of the second coil 20 being used subsidiarily.

Further, as illustrated in FIG. 5, when the coil component 1 operates in the MPP mode (second power transmission mode), the switch SW1 is turned OFF and the switch SW2 is turned ON. As a result, the first coil 10 is disconnected from the first winding part 20A of the second coil 20, and then the first winding part 20A is connected in series with the second winding part 20B. That is, the combination of the first winding part 20A and the second winding part 20B forms a single coil, and the entire second coil 20 functions as the MPP coil. The pair of terminals of the MPP coil are denoted by the outer peripheral end 20Ao of the first winding part 20A and the inner peripheral end 20Bi of the second winding part 20B, and a power transmission circuit is connected between the terminals to supply transmission power. As described above, in the MPP mode, the second coil 20 is used.

When the first coil 10 is used to transmit power in the EPP mode, the second magnetic body 32 is present in the power transmission path, so that magnetic coupling near the center of the charging area is reduced. However, according to the present embodiment, the first winding part 20A of the second coil 20, which is positioned on the power reception coil 61 side relative to the second magnetic body 32, is connected to the first coil 10, and the first coil is driven together with the part of the second coil 20, thereby suppressing a reduction in magnetic coupling near the center of the charging area. Although the first winding part 20A of the second coil 20 is disposed above the first coil 10 with the magnetic body 32 interposed therebetween, it can function as the EPP mode coil. This makes it possible to enhance power transmission efficiency in the EPP mode using the first coil 10.

The above demonstrates a case where the winding direction of the second coil 20 is the same as that of the first coil 10, and the following demonstrates a case where the winding direction of the second coil 20 is opposite to that of the first coil 10.

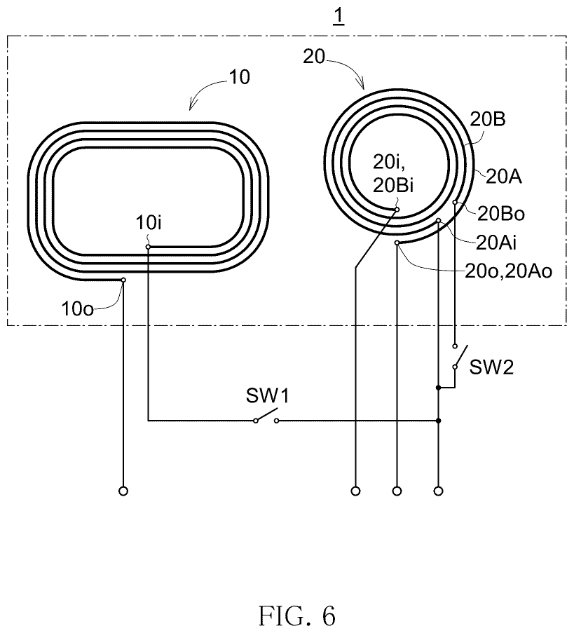

FIG. 6 is a schematic view illustrating another example of the electrical connection between the first and second coils 10 and 20.

As illustrated in FIG. 6, the first coil 10 is wound clockwise from the outer peripheral end 10o toward the inner peripheral end 10i, whereas the second coil 20 is wound counterclockwise from the outer peripheral end 20o toward the inner peripheral end 201. In this case, the inner peripheral end 10i of the first coil 10 is connected not to the outer peripheral end 20Ao of the first winding part 20A of the second coil 20, but to the inner peripheral end 20Ai of the first winding part 20A. The other configurations are the same as those illustrated in FIG. 3.

When current flows from the outer peripheral end 10o of the first coil 10 toward the inner peripheral end 10i thereof, the current flows clockwise. Likewise, when current flows from the inner peripheral end 20Ai of the first winding part 20A toward the outer peripheral end 20Ao thereof, the current also flows clockwise. This enables the loop current in the first coil 10 and the loop current in the first winding part 20A to flow in the same direction, allowing the first winding part 20A to function as part of the first coil 10.

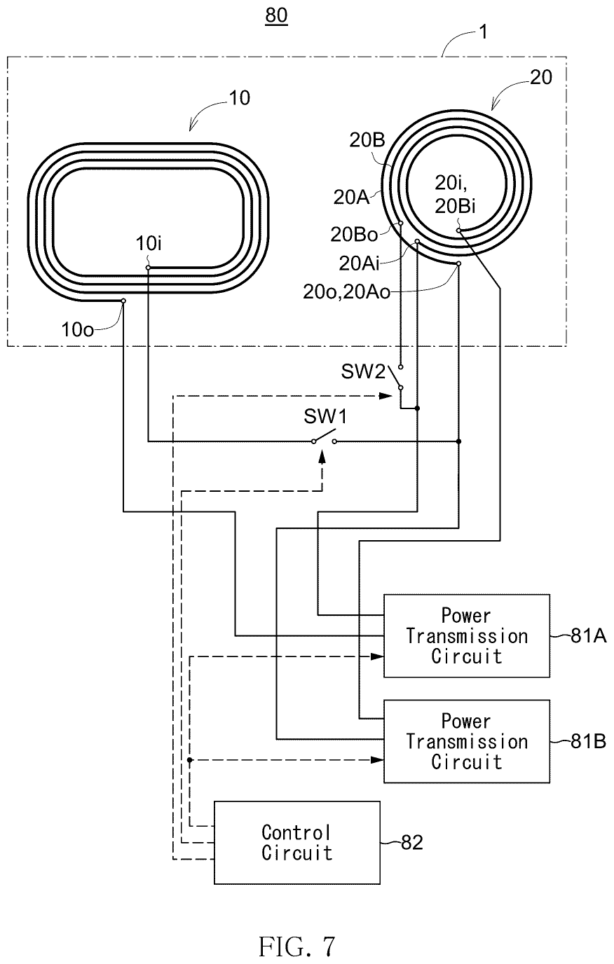

FIG. 7 is a block diagram illustrating an example of the configuration of a wireless power transmission device 80 using the coil component 1.

The wireless power transmission device 80 illustrated in FIG. 7 includes the coil component 1 having the first and second coils 10 and 20, a power transmission circuit 81A connected to the series circuit of the first coil 10 and the first winding part 20A of the second coil 20, a power transmission circuit 81B connected to the second coil formed by the combination of the first and second winding parts 20A and 20B, and a control circuit 82 that controls the power transmission circuits 81A and 81B.

The wireless power transmission device 80 further includes the switches SW1 and SW2 for power transmission mode switching. The switch SW1 (first switch) is configured to switch the connection state between the first coil 10 and the first winding part 20A, while the switch SW2 (second switch) is configured to switch the connection state between the first winding part 20A and the second winding part 20B. The switches SW1 and SW2 may be semiconductor switches mounted on a circuit board on which the power transmission circuits 81A and 81B, the control circuit 82, and the like are mounted, or may be components forming part of the power transmission circuits 81A and 81B, the control circuit 82, or the like.

The control circuit 82 controls the switches SW1 and SW2 in accordance with the power transmission mode and exclusively activates one 4 the power transmission circuits 81A and 81B.

In the EPP mode, the switches SW1 and SW2 are turned ON and OFF, respectively, thereby connecting the series circuit of the first coil 10 and the first winding part 20A to the power transmission circuit 81A and disconnecting the second winding part 20B from the first winding part 20A. Subsequently, the power transmission circuit 81A supplies power to perform EPP mode power transmission using the first coil 10 and the part of the second coil 20.

In the MPP mode, the switches SW1 and SW2 are turned OFF and ON, respectively, thereby connecting the second coil 20 to the power transmission circuit 81B and disconnecting the first coil 10 from the first winding part 20A. Subsequently, the power transmission circuit 81B supplies power to perform MPP mode power transmission using the second coil 20.

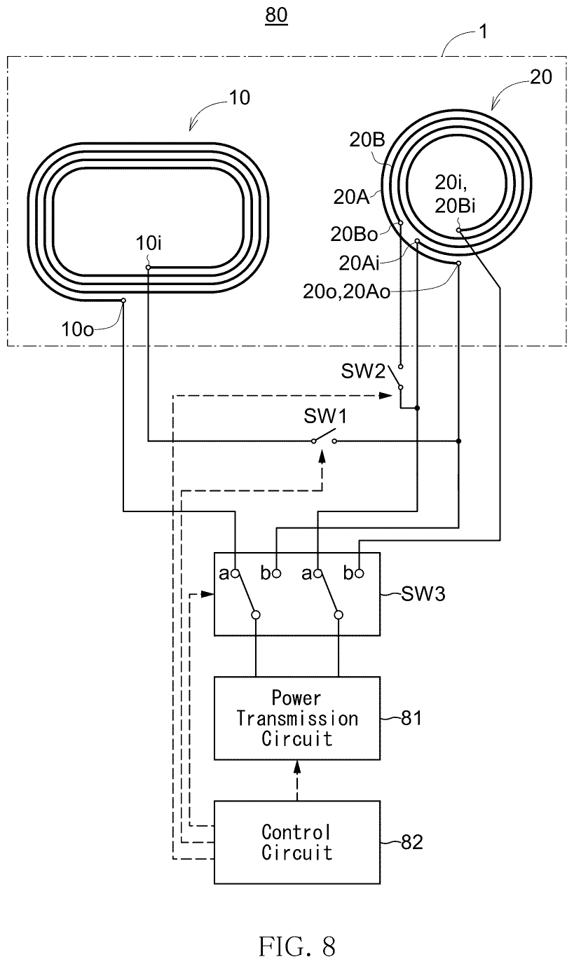

FIG. 8 is a block diagram illustrating another example of the configuration of the wireless power transmission device 80 using the coil component 1.

The wireless power transmission device 80 illustrated in FIG. 8 includes the coil component 1 having the first and second coils 10 and 20, a power transmission circuit 81 connected either to the series circuit of the first coil and the first winding part 20A of the second coil 20, or to the second coil 20 formed by the combination of the first and second winding parts 20A and 20B, a switch SW3 (third switch) provided between the first and second coils 10 and 20 and the power transmission circuit 81, and a control circuit 82 that controls the power transmission circuit 81 and the switch SW3.

The wireless power transmission device 80 further includes switches SW1 and SW2 for power transmission mode switching. The switches SW1 and SW2 may be semiconductor switches mounted on a circuit board on which the power transmission circuit 81, the control circuit 82, and the like are mounted, or may be components forming part of the power transmission circuit 81, the control circuit 82, or the like.

The control circuit 82 controls the switches SW1, SW2, and SW3 in accordance with the power transmission mode.

In the EPP mode, the switches SW1 and SW2 are turned ON and OFF, respectively, and the switch SW3 is connected to a contact a, thereby connecting the series circuit of the first coil 10 and the first winding part 20A of the second coil 20 to the power transmission circuit 81 and disconnecting the second winding part 20B from the first winding part 20A. Subsequently, the power transmission circuit 81 is driven to perform the EPP mode power transmission using the first coil 10 and the first winding part 20A of the second coil 20.

In the MPP mode, the switches SW1 and SW2 are turned OFF and ON, respectively, and the switch SW3 is connected to a contact b, thereby connecting the second coil 20 to the power transmission circuit 81 and disconnecting the first coil 10 from the first winding part 20A. Subsequently, the power transmission circuit 81 is driven to perform the MPP mode power transmission using the second coil 20.

In summary, in the wireless power transmission device 80 illustrated in FIG. 7, separate power transmission circuits are used for each power transmission mode. On the other hand, in the wireless power transmission device 80 illustrated in FIG. 8, a common power transmission circuit is used to drive the first coil 10 and the second coil 20, irrespective of the power transmission mode.

As described above, the coil component 1 according to the present embodiment includes the first magnetic body 31, first coil 10 disposed on the first magnetic body 31, the second coil 20 disposed above the first coil 10 and smaller in overall dimensions than the first coil 10, and the second magnetic body 32 disposed between the first and second coils 10 and 20. In the power transmission mode using the first coil 10, the part of the turns of the second coil 20 is used, so that it is possible to suppress a reduction in the magnetic coupling of the first coil 10 due to the influence of the second magnetic body 32 while providing a wide charging area. Further, the second magnetic body 32 is disposed between the first and second coils 10 and 20, thereby making it possible to enhance power transmission efficiency in the power transmission mode using the second coil 20.

The technology according to the present disclosure includes the following configuration examples, but not limited thereto.

A coil component according to an embodiment of the present disclosure includes: a first coil; a second coil disposed above the first coil; and a magnetic body disposed between the first coil and the second coil, wherein the first coil is configured to be connectable to a part of the turns of the second coil. According to the present disclosure, it is possible to suppress a reduction in magnetic coupling of the first coil due to the influence of the magnetic body provided between the first and second coils. This makes it possible to suppress a reduction in power transmission efficiency in either case where the first coil or the second coil is used.

In the above coil component, an outline size of the first coil may be larger than an outline size of the second coil. This makes it possible to provide a wide charging area.

In the above coil component, the first coil may be spaced apart from the second coil in the coil axis direction by a predetermined distance. This allows a device to be charged, such as a smartphone, to be charged without interference even if it has a protrusion.

In the above coil component, the second coil may include a first winding part located on an outer peripheral side of the second coil and a second winding part located on an inner peripheral side of the second coil relative to the first winding part, and the first coil may be configured to be connectable to the first winding part. This enables the use of the part of the second coil in wireless power transmission using the first coil, making it possible to suppress a reduction in magnetic coupling of the first coil due to the influence of the magnetic body.

In the above coil component, the number of turns of the first coil may be larger than the number of turns of the first winding part. This makes it possible to suppress a reduction in magnetic coupling of the first coil due to the influence of the magnetic body and to thereby enhance power transmission efficiency while providing a wide charging area.

In the above coil component, the inductance of the first coil may be larger than the inductance of the first winding part. This makes it possible to suppress a reduction in magnetic coupling of the first coil due to the influence of the magnetic body and to thereby enhance power transmission efficiency while providing a wide charging area.

In the above coil component, the planar shape of the first coil may have a longitudinal direction. Thus, even if the center position of a power reception coil is slightly displaced from the center position of the first coil to one side in the longitudinal direction of the first coil, a reduction in power transmission efficiency can be suppressed. That is, it is possible to provide a wide charging area and to deal with the displacement of the power reception coil.

The peripheral edge of the magnetic body may be provided with a protruding part that protrudes to the second coil side. This makes it possible to reduce the influence of a magnet disposed around the second coil while maintaining a sufficient inductance of the second coil.

The height at the upper end of the protruding part of the magnetic body may be larger than the height of the upper surface of the second coil. This makes it possible to reduce the influence of a magnet disposed around the second coil while maintain a sufficient inductance of the second coil.

The protruding part of the magnetic body may overlap the inner peripheral edge of the winding area of the first coil in a plan view. This makes it possible to suppress a reduction in magnetic coupling of the first coil due to the influence of the magnetic body.

The protruding part of the magnetic body may be located on the inner side of the inner peripheral edge of the winding area of the first coil in a plan view. This makes it possible to suppress a reduction in magnetic coupling of the first coil due to the influence of the magnetic body.

A wireless power transmission device according to the present disclosure includes any one of the above coil components and a power transmission circuit connected to the first and second coils of the coil component. This configuration enables a wireless power transmission device having a wide charging area and high power transmission efficiency.

Further, a wireless power transmission device according to another aspect of the present disclosure includes: any one of the above coil components; a first switch configured to switch the connection state between the first coil and the first winding part; a second switch configured to switch the connection state between first and second winding parts; a power transmission circuit connected to the first and second coils of the coil component; a third switch configured to connect the power transmission circuit to a series circuit of the first coil and the first winding part, or to the second coil; and a control circuit configured to control the first switch, the second switch, the third switch, and the power transmission circuit. This configuration enables a wireless power transmission device having a wide charging area and high power transmission efficiency.

In a first power transmission mode using the first coil, the control circuit may control the first switch to connect the first winding part in series with the first coil, the second switch to disconnect the first winding part from the second winding part, and the third switch to connect the power transmission circuit to the series circuit of the first coil and the first winding part. This configuration makes it possible to suppress a reduction in power transmission efficiency in an EPP mode.

In a second power transmission mode using the second coil, the control circuit may control the first switch to disconnect the first winding part from the first coil, the second switch to connect the first winding part in series with the second winding part, and the third switch to connect the power transmission circuit to the second coil. This configuration makes it possible to suppress a reduction in power transmission efficiency in an MPP mode.

What is claimed is:

1. A coil component comprising:
a first coil;
a second coil disposed above the first coil; and
a magnetic body disposed between the first coil and the second coil,
wherein the first coil is configured to be connectable to a part of turns of the second coil.

2. The coil component as claimed in claim 1, wherein an outline size of the first coil is larger than an outline size of the second coil.

3. The coil component as claimed in claim 1, wherein the first coil is spaced apart from the second coil in a coil axis direction by a predetermined distance.

4. The coil component as claimed in claim 1,
wherein the second coil includes a first winding part located on an outer peripheral side of the second coil and a second winding part located on an inner peripheral side of the second coil relative to the first winding part, and
wherein the first coil is configured to be connectable to the first winding part.

5. The coil component as claimed in claim 4, wherein a number of turns of the first coil is larger than a number of turns of the first winding part.

6. The coil component as claimed in claim 4, wherein an inductance of the first coil is larger than an inductance of the first winding part.

7. The coil component as claimed in claim 1, wherein a planar shape of the first coil has a longitudinal direction.

8. The coil component as claimed in claim 1, wherein a peripheral edge of the magnetic body is provided with a protruding part that protrudes to the second coil side.

9. The coil component as claimed in claim 8, wherein a height at an upper end of the protruding part of the magnetic body is larger than a height of an upper surface of the second coil.

10. The coil component as claimed in claim 8, wherein the protruding part of the magnetic body overlaps an inner peripheral edge of a winding area of the first coil in a plan view.

11. The coil component as claimed in claim 8, wherein the protruding part of the magnetic body is located on an inner side of an inner peripheral edge of a winding area of the first coil in a plan view.

12. A wireless power transmission device comprising:
a coil component as claimed in claim 1; and
a power transmission circuit connected to the first and second coils of the coil component.
